(19) United States
(12) Patent Application Publication
(10) Pub. No.: US 2013/0108351 A1
(43) Pub. Date: May 2, 2013

(54) Disposable Antiperspirant/Deodorant Applicator

(71) Applicant: Vicki Yeats, Lake Tapps, WA (US)

(72) Inventor: Vicki Yeats, Lake Tapps, WA (US)

(21) Appl. No.: 13/287,063

(22) Filed: Nov. 1, 2011

(51) Int. Cl. A45D 34/04; A61Q 15/00

(52) U.S. Cl. 401/132; 132/200

(57) ABSTRACT

The present invention is a water insoluble substrate material that has a liquid antiperspirant or deodorant composition deposited into a substrate. This insoluble substrate is held in an applicator and applied to the body to hide or prevent body odors. The applicator allows the user to apply the antiperspirant or deodorant to the affected areas without getting the liquid on the hands. The applicator is small and non-porous, which allows the user to transport and store the antiperspirant or deodorant in a purse or wallet.

### BACKGROUND

1. Field of the Invention

The field of the invention relates to a deodorant/ antiperspirant applicator that is designed for convenient storage and to be one time use.

2. Prior Art

A variety of personal care products are now commercially available in towelette applied form. Hair grooming compositions, facial cleansers and hand cleansers are delivered through transfer from disposable cloths. A series of patent documents have described disposable personal cleansing products in the form of substantially dry woven or non-woven cloths onto which are deposited cleansing compositions that include surfactant, structurant, skin conditioning agents and other performance ingredients. The technology is described in U.S. Pat. No. 5,951,991 (Wagner et al.), U.S. Pat. No. 5,980,931 (Fowler et al.) and 20 WO 99/55303 (Albacarys et al.).

U.S. Pat. No. 6,743,418 (Buford et al.) describes a deodorant pad that comprises a towelette which would be included within an aluminum foil package. Each towelette would be approximately two inches by two inches. Each towelette would be immersed in a solution of baby powder, baking soda, deodorant, and water.

U.S. Pat. No. 5,403,588 (Santa Ana) A body deodorant composition consists essentially of a combination of 70% isopropyl alcohol, acetone and aluminum chloride in individual amounts which provide improved cleansing and deodorizing effects. The body deodorizing composition is incorporated into an absorbent cotton pad as a solution and packaged in individual pouches for use.

These disposable personal cleansing and deodorant products in the prior art are intended for manual application to the body and therefore, the deposited material must not be undesirable to also have on the hands. These products would not be useful for applying a product that is undesirable to also have on the hands such as antiperspirant. Also, the purpose of these products is frustrated by the need to wash hands after use wherein the purpose of these products is convenient application of deodorant away from home.

### SUMMARY OF THE INVENTION

Due to travel or sudden temperature changes, a person may be caught away from home in hot or humid weather. The heat and humidity will cause unsightly moisture on clothing or unseemly odor from the armpits or other private areas. This odor or moisture on the clothing can cause embarrassment and discomfort.

Most deodorants melt in hot weather and could cause a mess in a purse or in an automobile. Deodorant sticks are also bulky and therefore undesirable to be carried around for emergency use. There are also towelettes or pads on the market that have deodorant or antiperspirant on them but a person must hold the towelette in the hands and apply to the underarm or other area. If the need for a disposable deodorant towelette arises then the person is probably away from home and will not have the luxury of hand washing. Having antiperspirant on the hands is undesirable because its active ingredient dries the hands. It is therefore the object of this invention, to provide a one-time-use applicator that contains an antiperspirant or deodorant composition that can be stored or transported in a purse or bag. This would allow a user to apply deodorant or antiperspirant away from home as the need arises. It is also the object of the present invention to provide a water insoluble substrate material that has a liquid antiperspirant or deodorant composition deposited into the substrate. The substrate material is contained in water proof wrapping that when torn will expose a portion of the substrate material and the user can hold the remaining water proof packaging and apply to the underarm or other areas. The substrate material must comprise soft materials that are somewhat stiff such as a non-latex sponge or a cotton mixture to prevent irritation of sensitive areas while being stiff enough to wipe against the body without folding back on the users hands.

An example substrate material can be a non-woven fabric similar to the type used in baby wipes, diapers, and dryer sheets. Traditional fabrics are made by weaving together fibers of silk, cotton, polyester, wool, and similar materials to form an interlocking matrix of loops. Non-woven fabrics, on the other hand, are made by a process that presses a single sheet of material from a mass of separate fibers. Fibers, such as cotton and rayon, are used in this process, as well as plastic resins like polyester, polyethylene, and polypropylene.

The sponge can be made from cellulose wood fibers, foamed plastic polymers or natural sponge. All synthetic sponges have benefits and are included in the invention for instance, low-density polyether, polyvinyl alcohol, polyester, and polyurethane.

A thick portion of non-woven fabric or a sponge is then individually sealed in a water tight package. These deodorant applicator packages are simple to store and transport. The deodorant applicator packages can be commonly known aluminum foil with plastic layer. The applicator packages can be any material that is water proof, sealed along the edges and can be torn with normal force from two fingers.

When the need arises the disposable deodorant applicator can be taken out of the purse or glove box and the top half of the package ripped off. The substrate that has been impregnated with deodorant or antiperspirant is fastened to the bottom half of the packaging, not allowing it to separate. This allows the user to hold the bottom half of the packaging and apply the product to the underarm without getting any liquid on the hands. As the liquid deodorant leaves the substrate material and is deposited on the skin, the force of wicking draws more liquid up the substrate material allowing full utilization of the entire amount of liquid despite only half the material being exposed to the under arm skin. The packaging can be any water proof container from plastic coated foil to injection molded plastic containers with detachable lids. The basic premise of the invention is using a substrate wick to draw fluid out of a container to apply antiperspirant or deodorant to the body.

### BRIEF DESCRIPTION OF THE DRAWINGS

FIG. 1: Front view of the disposable deodorant applicator with the top end removed.

FIG. 2: Side view of the disposable deodorant applicator depiction how to hold the device to prevent fluid contact with the hands.

FIG. 3: Front view of the disposable deodorant applicator with the top end and bottom end connected.

FIG. 4: Side view of the disposable deodorant applicator with the top end and bottom end connected.

FIG. 5: Cut view from FIG. 3 showing the internal parts of the disposable deodorant applicator. The location of the attachment of the substrate to the bottom end is shown.

FIG. 6: Front view of an alternate embodiment where the applicator is made from plastic.

FIG. 7: Front view of the alternate embodiment from FIG. 6 depicting proper holding to prevent fluid contact with the hands.

FIG. 8: Side view of an alternate applicator embodiment where the substrate is wedge shaped sponge.

FIG. 9: Side view of FIG. 8 with the top end removed to show sponge material and proper holding technique to prevent fluid contact with the hands.

FIG. 10: Isometric view of applicators joined by perforations at each end.

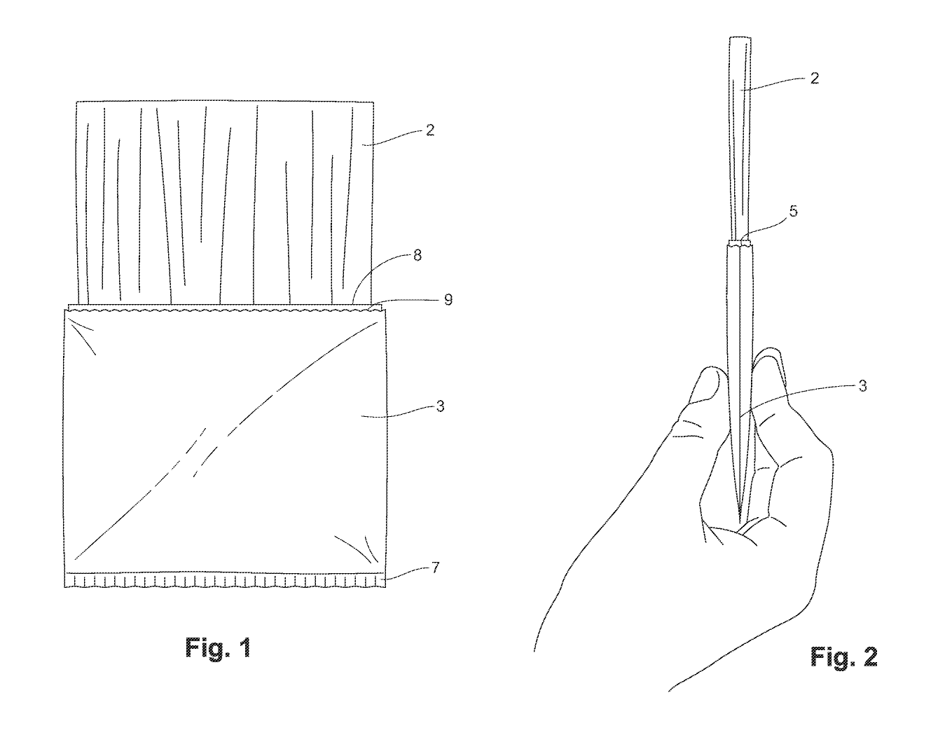

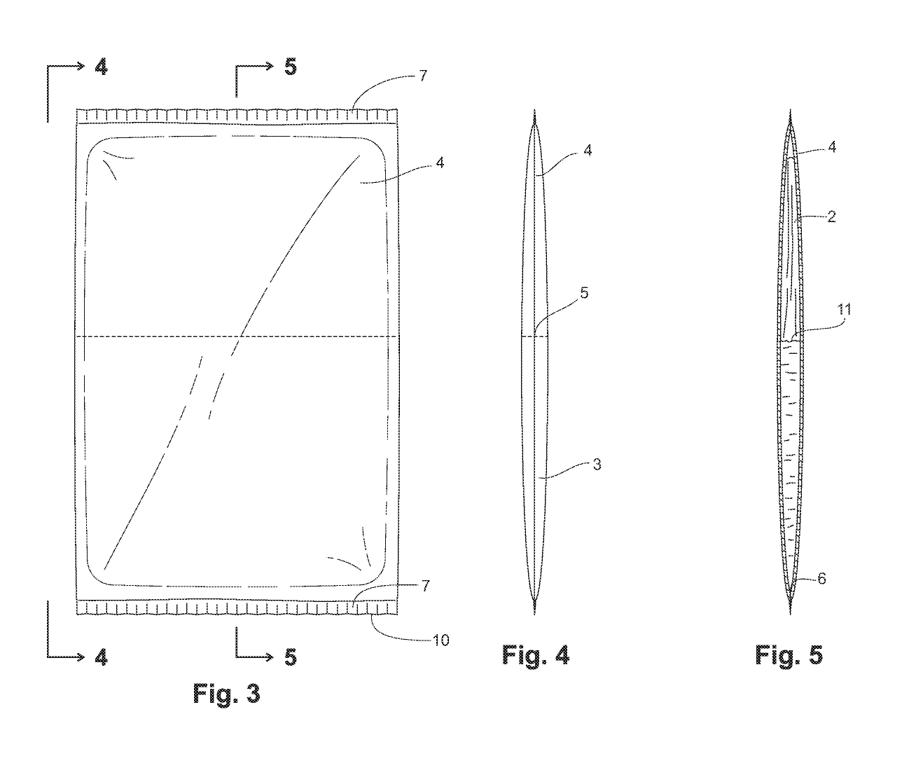

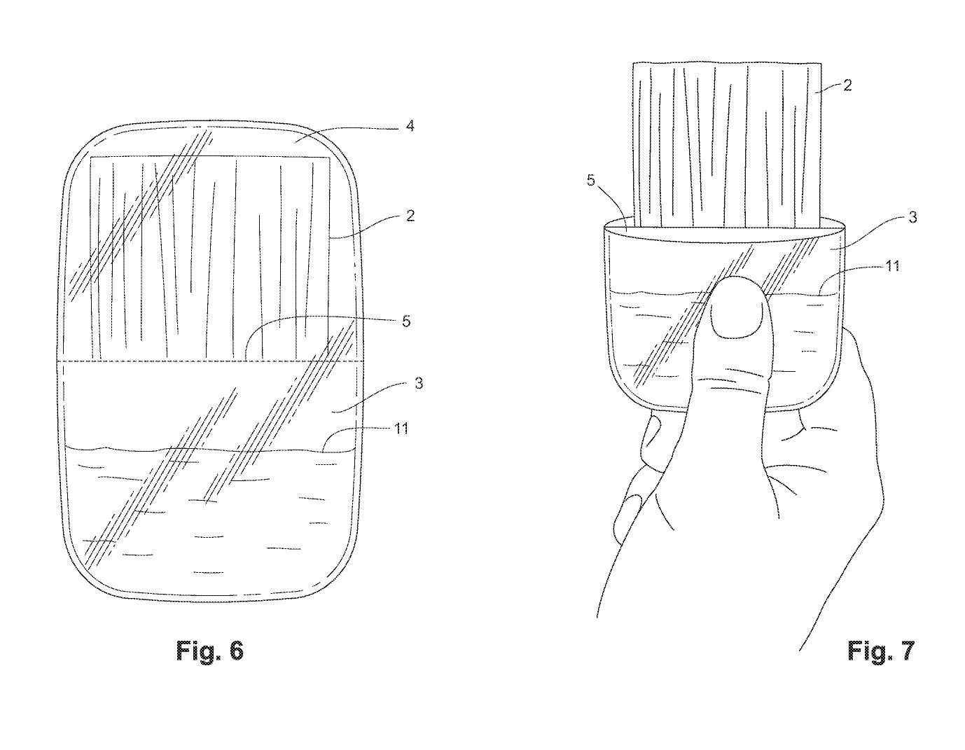

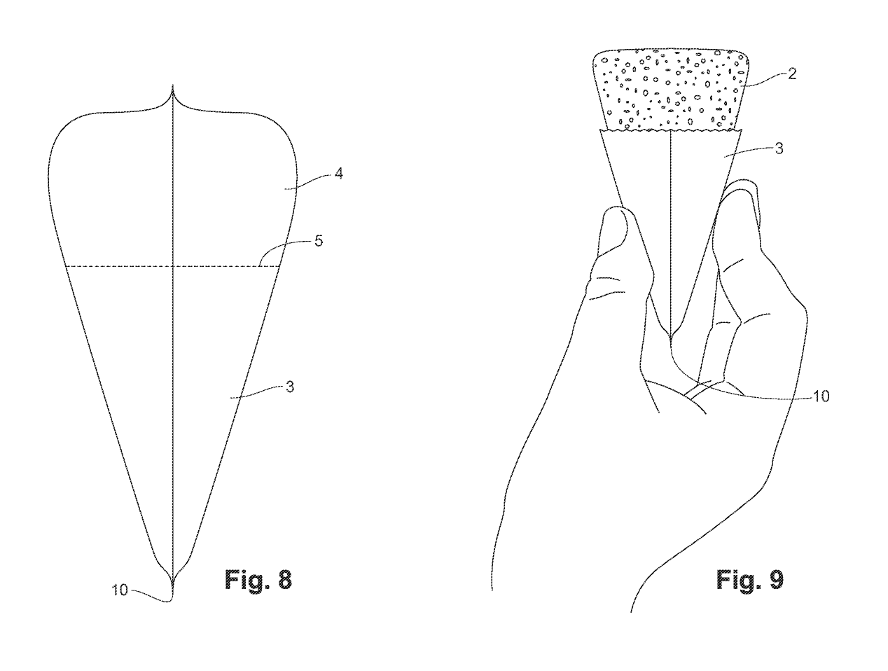

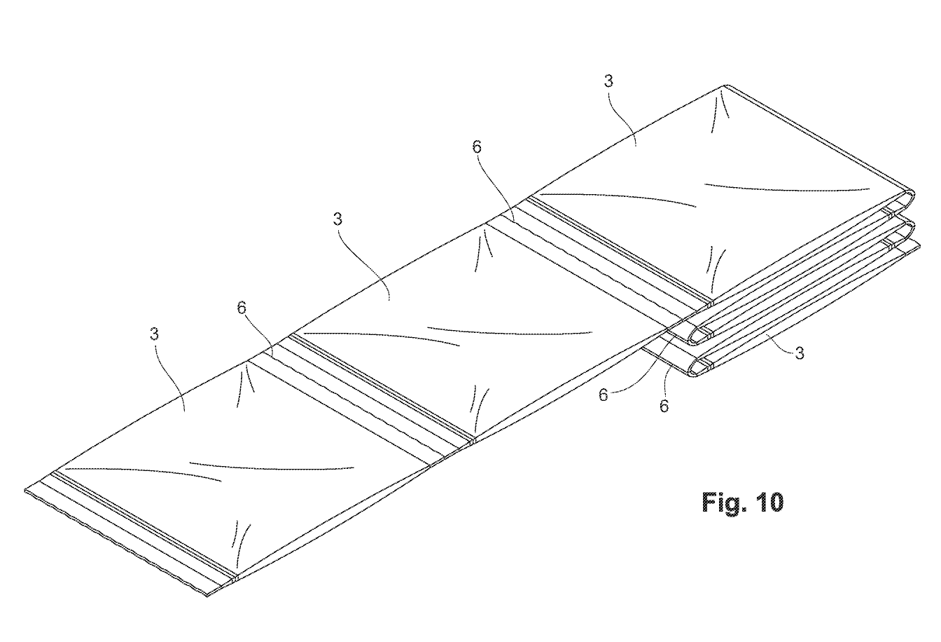

### DETAILED DESCRIPTION OF THE PREFERRED EMBODIMENTS

The new and improved antiperspirant or deodorant applicator 1 of the present invention is a water non-soluble substrate material 2 that is impregnated with a composition 11 having deodorant or antiperspirant properties contained in a waterproof applicator bottom end 3. The applicator top end 4 is attached to the applicator bottom end 3 by perforations in the continuous material. The substrate material 2 should be soft to prevent irritation to sensitive areas that typically sweat. The substrate material 2 should also be stiff to allow the typical pressure associated with application to the skin without folding back onto the users hands. These substrate materials 2 are cotton, rayon, or plastic resins like polyester, polyethylene, and polypropylene. The substrate material 2 may also be sponge material such as non-latex polyurethane, polymers, cellulose, or natural sponge. The substrate material 2 is attached to the applicator bottom end 3 by a means for attachment. The means for attachment can be adhesive, mechanical attachment, or sealed into the seal 7 of the applicator 1. The sealed package is lined with non-permeable material 8 to maintain the moisture content in the substrate material. The sealed package 3 is also lined with a stiff material 9 such as paper or foil that can be easily torn to allow facile access to the antiperspirant or deodorant impregnated substrate material 2. The sealed package 3 can be connected to other sealed applicators 1 through perforations 10 to allow facile package separation.

The preferred embodiment of the invention has a means for opening 5 the applicator 1 between applicator top end 4 and the applicator bottom end 3. The means for opening 5 is preferably perforations at the centerline of the applicator 1 parallel to the perforations 10 at the applicator 1 edge. The means for opening 5 can also be a mechanical locking feature on the edge of a manufactured applicator bottom end 3 and on a manufactured applicator top end 4.

The deodorant/antiperspirant composition 11 is held in the applicator bottom end 3 and is wicked up the substrate 2 as the deodorant/antiperspirant composition 11 is applied to the body.

The preferred embodiment is also the method of applying antiperspirant or deodorant by first removing the applicator top end 4 while the substrate material 2 remains protected by the applicator bottom end 3. Second, hold the applicator bottom end 3. Third, rub the substrate material 2 to the desired body area. Fourth, as the deodorant/antiperspirant composition 11 leaves the high concentration on the substrate to the low concentration of skin, the deodorant/antiperspirant composition 11 is replaced by wicking more composition from the applicator bottom end 3. Lastly, the applicator 1 is disposed of in a trash receptacle.

Having described the invention, what is claimed is:

1. A disposable applicator comprising,
a water non-soluble substrate material that is impregnated with a composition beneficial to a user and is contained in a non-porous applicator bottom end and an applicator top end is attached to the applicator bottom end by a means for opening, wherein the substrate material is attached to the applicator bottom end by a means for attachment allowing a user to hold the non-porous material and apply the composition without soiling the user.

2. The disposable applicator of claim 1 wherein, the water non-soluble substrate material is impregnated with a composition having deodorant or antiperspirant properties.

3. The disposable applicator of claim 1 wherein, the substrate material is non-woven fabric that is soft and stiff.

4. The disposable applicator of claim 1 wherein, the substrate material is sponge.

5. The disposable applicator of claim 1 wherein, the substrate is attached to the applicator bottom end by being integrated into a seal forming a boundary around the applicator bottom end.

6. The disposable applicator of claim 1 wherein, applicator top end and bottom end are lined with non-permeable material and sealed around the periphery to maintain the moisture content in the substrate material, and is also lined with a stiff material such as paper or foil that can be easily torn to allow facile removal of the applicator top end.

7. The disposable applicator of claim 6 wherein, sealed disposable applicators are connected to other sealed applicators through perforations to allow facile package separation.

8. The disposable applicator of claim 6 wherein, the means for opening the applicator are perforations at the centerline of the applicator parallel to the applicator edge and forms a boundary between applicator top end and the applicator bottom end.

9. The disposable applicator of claim 1 wherein, the means for opening is a mechanical locking feature on the edge of a manufactured applicator bottom end and on and manufactured applicator top end.

10. The disposable applicator of claim 1 wherein, the composition is held in the applicator bottom end and is wicked through the substrate as the composition is applied to the body.

11. A disposable applicator comprising,
a water non-soluble substrate material that is impregnated with a composition having deodorant or antiperspirant properties contained in a waterproof applicator bottom end, a applicator top end is attached to the applicator bottom end by a means for opening, wherein the substrate material is attached to the applicator bottom end by a means for attachment allowing a user to hold the non-porous material and apply the composition without soiling the user.

12. The disposable applicator of claim 11 wherein, the substrate material is non-woven fabric that is soft and stiff and is attached to the applicator bottom end by being integrated into a seal forming a boundary around the applicator bottom end.

13. The disposable applicator of claim 11 wherein, the substrate material is sponge is attached to the applicator bottom end by being integrated into a seal forming a boundary around the applicator bottom end.

14. The disposable applicator of claim 11 wherein, applicator top end and bottom end are lined with non-permeable material and sealed around the periphery to maintain the moisture content in the substrate material, and is also lined with a stiff material such as paper or foil that can be easily torn to allow facile removal of the applicator top end and the means for opening the applicator are perforations at the centerline of the applicator parallel to the applicator edge and forms a boundary between applicator top end and the applicator bottom end.

15. A method for applying an antiperspirant composition to the body comprising the steps; first, removing an applicator top end while a portion of a substrate material remains surrounded by an applicator bottom end, second, hold the applicator bottom end, third, rub the substrate material to a desired body area, fourth, as an antiperspirant composition leaves the high concentration on the substrate to the low concentration adjacent to the skin, the antiperspirant composition is replaced by wicking more composition from the applicator bottom end and lastly, disposing of the applicator in a trash receptacle.

16. The method of claim 15 wherein, the substrate material is one inch by one inch nonwoven fabric.

17. The method of claim 15 wherein, the substrate material is wedge shaped sponge.

18. The method of claim 15 wherein, the applicator top end and bottom end are made from non-porous foil

19. The method of claim 15 wherein, the applicator top end and bottom end are made from manufactured polymer.

20. The method of claim 19 wherein, the applicator is reused in lieu of being thrown in a trash receptacle.
